(19) United States
(12) Patent Application Publication
(10) Pub. No.: US 2021/0281873 A1
(43) Pub. Date: Sep. 9, 2021

(54) METHODS AND APPARATUSES OF CANDIDATE SET DETERMINATION FOR BINARY-TREE SPLITTING BLOCKS

(71) Applicant: MEDIATEK INC., Hsin-Chu (TW)

(72) Inventors: Chun-Chia CHEN, Hsinchu City (TW); Chih-Wei HSU, Hsinchu City (TW); Tzu-Der CHUANG, Zhubei City, Hsinchu County (TW); Ching-Yeh CHEN, Taipei City (TW); Yu-Wen HUANG, Taipei City (TW)

(21) Appl. No.: 16/330,122

(22) PCT Filed: Sep. 5, 2017
(86) PCT No.: PCT/CN2017/100532

§ 371 Date: Mar. 4, 2019

Related U.S. Application Data
(60) Provisional application No. 62/383,697, filed on Sep. 6, 2016.

(51) Int. Cl. H04N 19/52; H04N 19/96; H04N 19/176; H04N 19/119; H04N 19/46

(52) U.S. Cl. CPC H04N 19/52; H04N 19/96; H04N 19/46; H04N 19/119; H04N 19/176

(57) ABSTRACT

Video processing methods and apparatuses for candidate set determination for binary-tree splitting blocks comprise receiving input data of a current block partitioned from a parent block by binary-tree splitting, determining a candidate set for the current block by prohibiting a spatial candidate derived from a neighboring block partitioned from the same parent block or determining the candidate set for the current block by conducting a pruning process if the neighboring block is coded in Inter prediction, and encoding or decoding the current block based on the candidate set by selecting one final candidate from the candidate set. The pruning process comprises scanning the candidate set to determine if any candidate equals to the spatial candidate derived from the neighboring block, and removing the candidate equals to the spatial candidate from the candidate set.

### CROSS REFERENCE TO RELATED APPLICATIONS

The present invention claims priority to U.S. Provisional Patent Application, Ser. No. 62/383,697, filed on Sep. 6, 2016, entitled “A New Method for Video Coding”. The U.S. Provisional Patent Application is hereby incorporated by reference in its entirety.

### FIELD OF THE INVENTION

The present invention relates to video data processing methods and apparatuses encode or decode binary-tree splitting blocks. In particular, the present invention relates to candidate set determination for encoding or decoding the binary-tree splitting blocks.

### BACKGROUND AND RELATED ART

The High-Efficiency Video Coding (HEVC) standard is the latest video coding standard developed by the Joint Collaborative Team on Video Coding (JCT-VC) group of video coding experts from ITU-T Study Group. The HEVC standard relies on a block-based coding structure which divides each slice into multiple square Coding Tree Units (CTUs). In the HEVC main profile, the minimum and the maximum sizes of a CTU are specified by syntax elements signaled in the Sequence Parameter Set (SPS). A raster scan order is used to process the CTUs in a slice. Each CTU is further recursively divided into one or more Coding Units (CUs) using quad-tree partitioning method. At each depth of the quad-tree partitioning method, the N×N block is either a single leaf CU or split into four blocks of sizes N/2×N/2, which are coding tree nodes. If a coding tree node is not further split, it is the leaf CU. The CU size is restricted to be less than or equal to a minimum allowed CU size, which is also specified in the SPS. An example of the quad-tree block partitioning structure is illustrated in FIG. 1, where the solid lines indicate CU boundaries in CTU 100.

The prediction decision is made at the CU level, where each CU is coded using either Inter picture prediction or Intra picture prediction. Once the splitting of CU hierarchical tree is done, each CU is subject to further split into one or more Prediction Units (PUs) according to a PU partition type for prediction. FIG. 2 shows eight PU partition types defined in the HEVC standard. Each CU is split into one, two, or four PUs according to one of the eight PU partition types shown in FIG. 2. The PU works as a basic representative block for sharing the prediction information as the same prediction process is applied to all pixels in the PU. The prediction information is conveyed to the decoder on a PU basis. After obtaining residual data generated by the prediction process, the residual data belong to a CU is split into one or more Transform Units (TUs) according to another quad-tree block partitioning structure for transforming the residual data into transform coefficients for compact data representation. The dotted lines in FIG. 1 indicate TU boundaries. The TU is a basic representative block for applying transform and quantization on the residual data. For each TU, a transform matrix having the same size as the TU is applied to the residual data to generate transform coefficients, and these transform coefficients are quantized and conveyed to the decoder on a TU basis.

The terms Coding Tree Block (CTB), Coding block (CB), Prediction Block (PB), and Transform Block (TB) are defined to specify two dimensional sample array of one color component associated with the CTU, CU, PU, and TU respectively. For example, a CTU consists of one luma CTB, two chroma CTBs, and its associated syntax elements. In the HEVC system, the same quad-tree block partitioning structure is generally applied to both luma and chroma components unless a minimum size for chroma block is reached.

An alternative partitioning method is called binary-tree block partitioning method, where a block is recursively split into two smaller blocks. FIG. 3 illustrates six exemplary split types for the binary-tree partitioning method including symmetrical splitting 31 and 32 and asymmetrical splitting 33, 34, 35 and 36. A simplest binary-tree partitioning method only allows symmetrical horizontal splitting 32 and symmetrical vertical splitting 31. For a given block with size N×N, a first flag is signaled to indicate whether this block is partitioned into two smaller blocks, followed by a second flag indicating the split type if the first flag indicates splitting. This N×N block is split into two blocks of size N×N/2 if the split type is symmetrical horizontal splitting, and this N×N block is split into two blocks of size N/2×N if the split type is symmetrical vertical splitting. The splitting process can be iterated until the size, width, or height of a splitting block reaches a minimum allowed size, width, or height defined by a high level syntax in the video bitstream. Horizontal splitting is implicitly not allowed if a block height is smaller than the minimum height, and similarly, vertical splitting is implicitly not allowed if a block width is smaller than the minimum width.

FIGS. 4A and 4B illustrate an example of block partitioning according to a binary-tree partitioning method and its corresponding coding tree structure. In FIG. 4B, one flag at each splitting node (i.e., non-leaf) of the binary-tree coding tree is used to indicate the split type, flag value equals to 0 indicates horizontal symmetrical splitting while flag value equals to 1 indicates vertical symmetrical splitting. It is possible to apply the binary-tree partitioning method at any level of block partitioning during encoding or decoding, for example, the binary-tree partitioning method may be used to partition a slice into CTUs, a CTU into CUs, a CU in PUs, or a CU into TUs. It is also possible to simplify the partitioning process by omitting the splitting from CU to PU and from CU to TU, as the leaf nodes of a binary-tree block partitioning structure is the basic representative block for both prediction and transform coding.

Although the binary-tree partitioning method supports more partition structures and thus is more flexible than the quad-tree partitioning method, the coding complexity increases for selecting the best partition shape among all possible shapes. A combined partitioning method called Quad-Tree-Binary-Tree (QTBT) structure combines a quad-tree partitioning method with a binary-tree partitioning method, which balances the coding efficiency and the coding complexity of the two partitioning methods. An exemplary QTBT structure is shown in FIG. 5A, where a large block is firstly partitioned by a quad-tree partitioning method then a binary-tree partitioning method. FIG. 5A illustrates an example of block partitioning structure according to the QTBT partitioning method and FIG. 5B illustrates a coding tree diagram for the QTBT block partitioning structure shown in FIG. 5A. The solid lines in FIGS. 5A and 5B indicate quad-tree splitting while the dotted lines indicate binary-tree splitting. Similar to FIG. 4B, in each splitting (i.e., non-leaf) node of the binary-tree structure, one flag indicates which splitting type is used, 0 indicates horizontal symmetrical splitting and 1 indicates vertical symmetrical splitting. The QTBT structure in FIG. 5A splits the large block into multiple smaller blocks, and these smaller blocks may be processed by prediction and transform coding without further splitting. In an example, the large block in FIG. 5A is a coding tree unit (CTU) with a size of 128×128, a minimum allowed quad-tree leaf node size is 16×16, a maximum allowed binary-tree root node size is 64×64, a minimum allowed binary-tree leaf node width or height is 4, and a minimum allowed binary-tree depth is 4. In this example, the leaf quad-tree block may have a size from 16×16 to 128×128, and if the leaf quad-tree block is 128×128, it cannot be further split by the binary-tree structure since the size exceeds the maximum allowed binary-tree root node size 64×64. The leaf quad-tree block is used as the root binary-tree block that has a binary-tree depth equal to 0. When the binary-tree depth reaches 4, non-splitting is implicit; when the binary-tree node has a width equal to 4, non-vertical splitting is implicit; and when the binary-tree node has a height equal to 4, non-horizontal splitting is implicit. For CTUs coded in I slice, the QTBT block partitioning structure for a chroma coding tree block (CTB) can be different from the QTBT block partitioning structure for a corresponding luma CTB. For CTUs coded in P or B slice, the same QTBT block partitioning structure may be applied to both chroma CTBs and luma CTB.

Skip and Merge modes in the HEVC standard reduce the data bits for signaling motion information by inheriting motion information from a spatially neighboring block or a temporal collocated block. For a PU coded in Skip or Merge mode, only an index of a selected final candidate is coded instead of the motion information, as the PU reuses the motion information including a motion vector (MV), a prediction direction and a reference picture index of the selected final candidate. Prediction errors, also called the residual data, are coded when the PU is coded in Merge mode, however, the skip mode further skips signaling of the residual data as the residual data is forced to be zero. FIG. 6 illustrates a Merge candidate set for a current block 60, where the Merge candidate set consists of four spatial Merge candidates and one temporal Merge candidate defined in HEVC test model 3.0 (HM-3.0) during the development of the HEVC standard. The first Merge candidate is a left predictor Am 620, the second Merge candidate is a top predictor Bn 622, the third Merge candidate is a temporal predictor of a first available temporal predictors of T_{BR} 624 and T_{CTR} 626, the fourth Merge candidate is an above right predictor B0 628, and the fifth Merge candidate is a below left predictor A0 630. The encoder selects one final candidate from the candidate set for each PU coded in Skip or Merge mode based on a rate-distortion optimization (RDO) decision, and an index representing the selected final candidate is signaled to the decoder. The decoder selects the same final candidate from the candidate for according to the index transmitted in the video bitstream.

FIG. 7 illustrates a Merge candidate set for a current block 70 defined in HM-4.0, where the Merge candidate set consists of up to four spatial Merge candidates derived from four spatial predictors A₀ 720, A₁ 722, B₀ 724, and B₁726, and one temporal Merge candidate derived from temporal predictor T_{BR} 728 or temporal predictor T_{CTR} 730. The temporal predictor T_{CTR} 730 is selected only if the temporal predictor T_{BR} 728 is not available. An above left predictor B₂ 732 is used to replace an unavailable spatial predictor. A pruning process is applied to remove redundant Merge candidates after the derivation process of the four spatial Merge candidates and one temporal Merge candidate. Three types of additional candidates are derived and added to the Merge candidate set if the number of Merge candidates is less than five after the pruning process.

### BRIEF SUMMARY OF THE INVENTION

Methods and apparatuses of determining candidate set for a binary-tree splitting block in a video coding system comprises receiving input data associated with a current block in a current picture, determining a candidate set for the current block, and encoding or decoding the current block based on the candidate set by selecting one final candidate from the candidate set. The current block is a binary-tree splitting block partitioned from a parent block. Some embodiments of the present invention determine the candidate set for the current block by prohibiting a spatial candidate derived from a neighboring block partitioned from the same parent block as the current block if the neighboring block is coded in Inter prediction, for example, the spatial candidate derived from the neighboring block is removed from the candidate set if the neighboring block is coded in Advance Motion Vector Prediction (AMVP) mode, Merge mode, or Skip mode. The current block reuses motion information of the selected final candidate for motion compensation to derive a predictor for the current block.

In one embodiment, a flag is signaled to indicate whether the candidate set prohibits the spatial candidate derived from the neighboring block, and the flag is signaled in a sequence level, picture level, slice level, or Prediction Unit (PU) level.

In some embodiment, the candidate set determination method further comprises a pruning process which scans the candidate set to determine if any candidate in the candidate set equals to the spatial candidate derived from the neighboring block, and removes the candidate equals to the spatial candidate from the candidate set. For example, the encoder or decoder stores motion information of the spatial candidate derived from the neighboring block and compares to motion information of each candidate in the candidate set. A flag signaled in a sequence level, picture level, slice level, or PU level may be used to indicate whether the pruning process is enabled or disabled.

In a variation of the candidate set determination method, the neighboring block is further split into multiple sub-blocks for motion estimation or motion compensation. The encoder or decoder further checks motion information inside the neighboring block to determine if the motion information inside the neighboring block are all the same. In one embodiment, any spatial candidate derived from the neighboring block is prohibited if the motion information inside the neighboring block are all the same and the sub-blocks are coded in Inter prediction. In another embodiment, a pruning process is performed if the motion information inside the neighboring block are all the same and the sub-blocks are coded in Inter prediction. The pruning process includes scanning the candidate set and removes any candidate from the candidate set which equals to the spatial candidate derived from any sub-block in the neighboring block. An embodiment determines whether the motion information inside the neighboring block are the same by checking every minimum block inside the neighboring block, the size of each minimum block is M×M and each sub-block is larger than or equal to the size of the minimum block. A flag may be signaled to indicate whether the candidate set prohibiting method or the pruning process is enabled or disabled.

Some other embodiments of candidate set determination for a current block partitioned from a parent block by binary-tree splitting determine a candidate set for the current block and determine motion information of a neighboring block partitioned from the same parent block, perform a pruning process according to the motion information of the neighboring block, and encoding or decoding the current block based on the candidate set by selecting one final candidate from the candidate set. The pruning process includes scanning the candidate set to determine if any candidate in the candidate set equals to the motion information of the neighboring block, and removing the candidate equals to the motion information of the neighboring block from the candidate set. A predictor is derived to encode or decode the current block based on motion information of the selected final candidate.

Aspects of the disclosure further provide an apparatus for the video coding system which determines a candidate set for a binary-tree splitting block. Embodiments of the apparatus receive input data of a current block partitioned from a parent block by binary-tree splitting, determine a candidate set for the current block by prohibiting a spatial candidate derived from a neighboring block partitioned from the same parent block if the neighboring block is coded in Inter prediction or determine a candidate set for the current block by performing a pruning process which removes any candidate having motion information equals to the motion information derived from the neighboring block. The apparatus encodes or decodes the current block based on the candidate set.

Aspects of the disclosure further provide a non-transitory computer readable medium storing program instructions for causing a processing circuit of an apparatus to perform video coding process to encode or decode a current block partitioned by binary-tree splitting based on a candidate set. The candidate set is determined by prohibiting a spatial candidate derived from a neighboring block partitioned from the same parent block as the current block or the candidate set is determined by performing a pruning process which removes any candidate equals to the spatial candidate derived from the neighboring block. Other aspects and features of the invention will become apparent to those with ordinary skill in the art upon review of the following descriptions of specific embodiments.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates an exemplary coding tree for splitting a Coding Tree Unit (CTU) into Coding Units (CUs) and splitting each CU into one or more Transform Units (TUs) according to the quad-tree partitioning method.

FIG. 2 illustrates eight different PU partition types for splitting a CU into one or more PUs defined in the HEVC standard.

FIG. 3 illustrates six exemplary split types of a binary-tree partitioning method.

FIG. 4A illustrates an exemplary block partitioning structure according to a binary-tree partitioning method.

FIG. 4B illustrates a coding tree structure corresponding to the block partitioning structure shown in FIG. 4A.

FIG. 5A illustrates an exemplary block partitioning structure according to a Quad-Tree-Binary-Tree (QTBT) partitioning method.

FIG. 5B illustrates a coding tree structure corresponding to the block partitioning structure of FIG. 5A.

FIG. 6 illustrates constructing a Merge candidate set for a current block defined in HEVC Test Model 3.0 (HM-3.0).

FIG. 7 illustrates constructing a Merge candidate set for a current block defined in HM-4.0.

FIG. 8A illustrates an example of the first embodiment of candidate set determination which prohibits a spatial candidate derived from motion information of a left neighboring block.

FIG. 8B illustrates another example of the first embodiment which prohibits a spatial candidate derived from motion information of an upper neighboring block.

FIGS. 9A-9D show four other examples of binary-tree splitting for generating a current block and a neighboring block, where motion information of the neighboring block are not included in a candidate set constructed for the current block.

FIGS. 10A-10B illustrate an example of the third embodiment applies spatial candidate prohibiting method for a current block, where a neighboring block of the current block is further split into sub-blocks in a binary-tree manner.

FIGS. 10C-10G illustrate the third embodiment applies to five other examples of binary-tree splitting.

FIG. 11 is a flow chart illustrating an embodiment of the video data processing method for coding a binary-tree splitting block by prohibiting a spatial candidate derived from a neighboring block during candidate set determination.

FIG. 12 is a flowchart illustrating another embodiment of video data processing method for coding a binary-tree splitting block by removing any candidate equals to motion information of a neighboring block during candidate set determination.

FIG. 13 illustrates an exemplary system block diagram for a video encoding system incorporating the video data processing method according to embodiments of the present invention.

FIG. 14 illustrates an exemplary system block diagram for a video decoding system incorporating the video data processing method according to embodiments of the present invention.

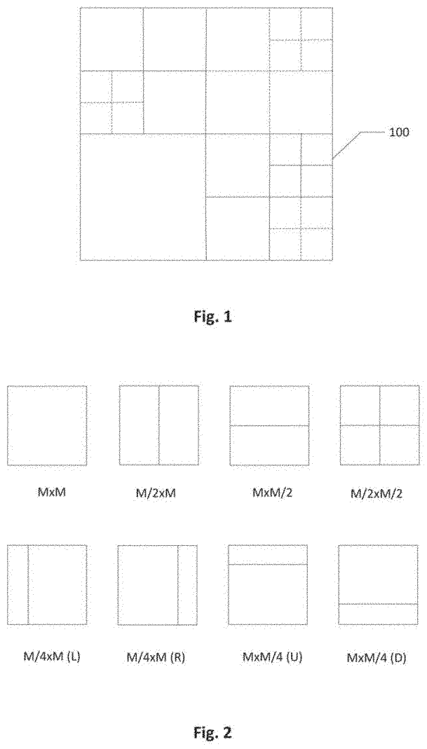

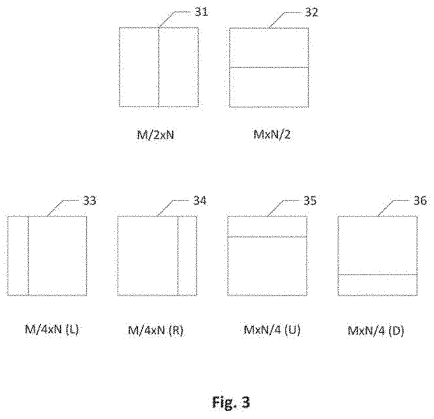

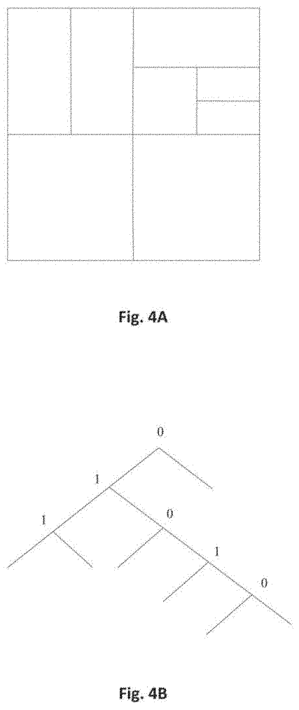

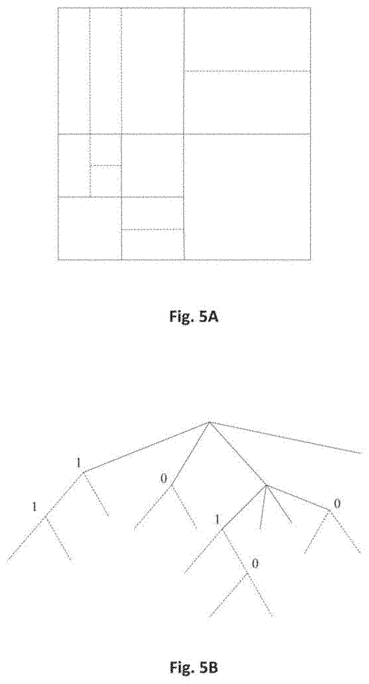

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

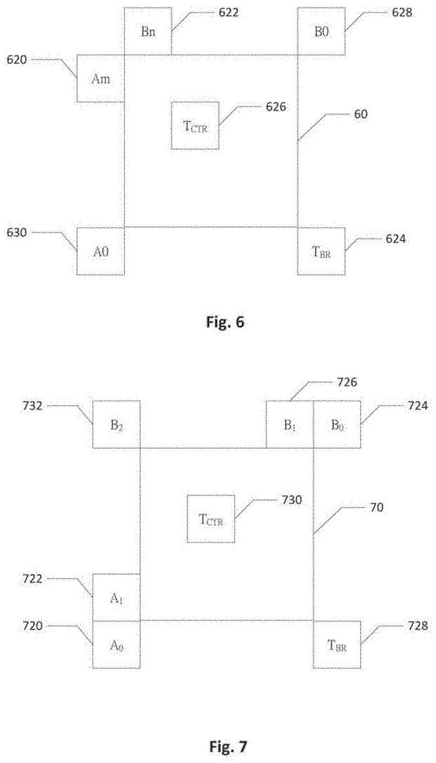

Embodiments of the present invention construct a candidate set for encoding or decoding a block partitioned by a binary-tree block partitioning method, for example, the block is partitioned by binary-tree splitting in the QTBT partitioning structure. In the following, only symmetrical horizontal splitting and symmetrical vertical splitting are demonstrated, however, the present invention may be applied to asymmetrical horizontal splitting and asymmetrical vertical splitting. The candidate set may be a Merge candidate set comprises one or more spatial candidates and temporal candidate as shown in FIG. 6 or FIG. 7. The candidate set is constructed for encoding or decoding a current block coded in one of the Inter modes. One final candidate is selected from the constructed candidate set, and the current block is encoded or decoded by deriving a predictor according to motion information of the final candidate.

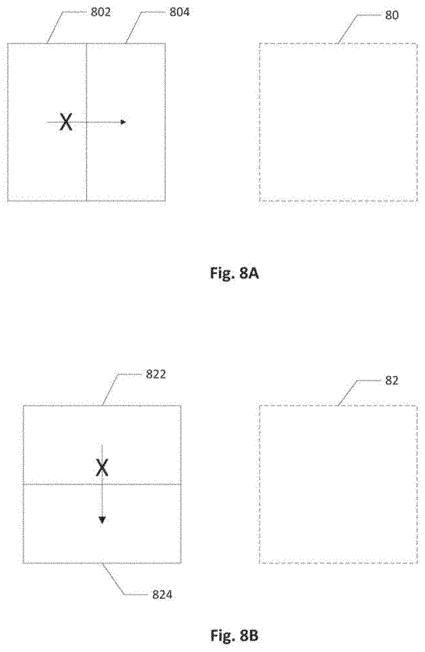

First Embodiment In a first embodiment of the present invention, a candidate set is determined from motion information of spatial and temporal neighboring blocks with a candidate prohibiting method if a current block is partitioned by binary-tree splitting. FIG. 8A illustrates an example of the first embodiment which prohibits selecting a spatial candidate for a current block 804 from motion information of a left neighboring block 802. The current block 804 and the left neighboring block 802 are binary-tree splitting blocks partitioned from the same parent block 80, for example, the current block 804 and the left neighboring block 802 are prediction blocks (PUs) partitioned by symmetrical vertical splitting. An example of the parent block 80 is a root node before binary-tree splitting in the QTBT structure, which is also called a leaf quad-tree block. To construct the candidate set for the current block 804 when the current block 804 is coded in Merge mode or Skip mode, the candidate prohibiting method always prohibits the spatial candidate from the left neighboring block 802 if the coding mode of the left neighboring block is Inter mode. The Inter mode includes Advance Motion Vector Prediction (AMVP) mode, Skip mode, and Merge mode. Motion information derived from the left neighboring block 802 cannot be added into the candidate set for the current block 804. By applying the first embodiment, merging the current block 804 into the left neighboring block 802 is not allowed if the current block 804 and the left neighboring block 802 are split from a parent block by a binary-tree splitting, and the left neighboring block 802 is coded in Inter prediction.

Similarly, FIG. 8B illustrates another example of the first embodiment which prohibits selecting a spatial candidate for a current block 824 from motion information of an upper neighboring block 822. The current block 824 and the upper neighboring block 822 are partitioned from a parent block 82 according to symmetrical horizontal splitting of binary-tree splitting. The first embodiment constructs a candidate set for the current block 824 by prohibiting or removing spatial candidate derived from the upper neighboring block 822 if the upper neighboring block 822 is coded in Inter prediction, where the Inter modes associated with the Inter prediction includes AMVP mode, Skip mode, and Merge mode.

A flag may be signaled to indicate whether the spatial candidate derived from a neighboring block sharing the same parent block as the current block is prohibited or removed from the candidate set of the current block. For example, a flag merge_cand_prohibit_en signaled in a sequence level, picture level, slice level, or PU level is used to indicate whether the candidate prohibiting method of the first embodiment is enabled. The value of this flag merge_cand_prohibit_en is inferred to be 1 indicating enabling of the candidate prohibiting method when this flag is not present.

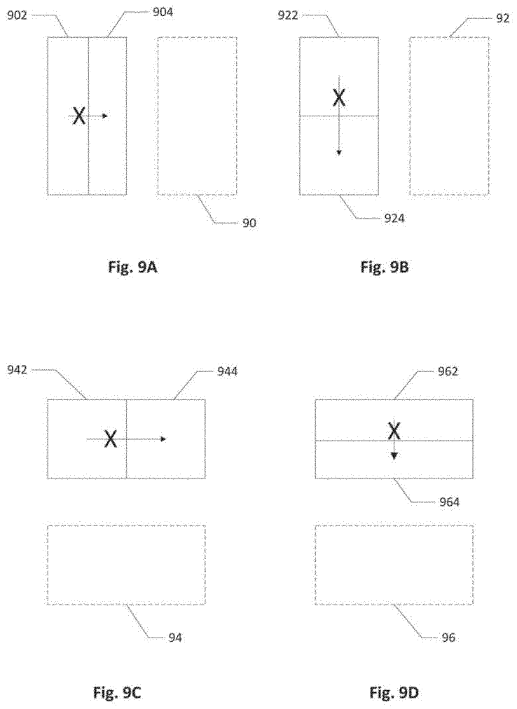

The general rule for the spatial candidate prohibiting method of the first embodiment is applicable to all kinds of binary-tree splitting. FIG. 9A to FIG. 9D show four examples of binary-tree splitting, where FIG. 9A and FIG. 9B illustrate cases when the block width is less than the block height before binary-tree splitting and FIG. 9C and FIG. 9D illustrate cases when the block width is greater than the block height before binary-tree splitting. A current block 904 and a left neighboring block 902 are partitioned from a parent block 90 according to vertical binary-tree splitting in FIG. 9A, and the current block 904 is to be encoded or decoded in Merge mode or Skip mode. When constructing a Merge candidate set for the current block 904, the spatial candidate prohibiting method of the first embodiment prohibits or removes a spatial candidate derived from the left neighboring block 902 from the Merge candidate set for the current block 904 if the left neighboring block 902 is coded in Inter prediction. FIG. 9B illustrates a current block 924 and an upper neighboring block 922 partitioned from a parent block 92 according to horizontal binary-tree splitting. A Merge candidate set is determined for the current block 924 when the current block 924 is to be coded in Merge mode or Skip mode, and the spatial candidate prohibiting method of the first embodiment prohibits or removes a spatial candidate derived from the upper neighboring block 922 from the Merge candidate set for the current block 924 if the upper neighboring block 922 is coded in Inter prediction. A current block 944 and a left neighboring block 942 are partitioned from a parent block 94 according to vertical binary-tree splitting in FIG. 9C, and a spatial candidate derived from the left neighboring block 942 is not allowed to be included in a Merge candidate set of the current block 944 if the left neighboring block 942 is coded in Inter prediction. FIG. 9D illustrates an upper neighboring block 962 and a current block 964 are partitioned from a parent block 96 according to horizontal binary-tree splitting. A spatial candidate derived from the upper neighboring block 962 is prohibited or removed from a Merge candidate set for the current block 964 if the upper neighboring block 962 is coded in Inter prediction. In the foregoing examples, the Inter prediction includes AMVP, Merge or Skip modes.

Second Embodiment In a second embodiment, a candidate set pruning method is applied to determine a candidate set for a current block when the current block and a neighboring block are partitioned from the same parent block by binary-tree splitting. The candidate set pruning method first determines motion information of the neighboring block partitioned from the parent block of the current block, and scans the candidate set to check if any candidate in the candidate set which motion information equals to the motion information of the neighboring block. The candidate which has the same motion information as the motion information of the neighboring block may be other spatial neighboring block or temporal collocated block. The candidate set pruning method removes one or more candidates with the same motion information as the neighboring block split from the same parent block of the current block. The second embodiment may be combined with the first embodiment to eliminate the motion information derived from the neighboring block as well as any candidate in the Merge candidate set which has the same motion information as the neighboring block.

An example of the candidate set pruning process of the second embodiment may be described by pseudo codes in the following, where part B is a current block and part A is a neighboring block splitting from the same parent block as the current block. Part A is a left block if part B is a right block of the parent block, or part A is an upper block if part B is a below block of the parent block. In the pseudo codes, Merge_skip_mode_cand_list_build (part B) is a process to construct the Merge mode or Skip mode candidate set for part B. Motion information of part A (MotionInfo_part_A) is set as the prune motion information, where Prune_MI is a variable to store the motion information. The candidate set for part B built from spatial and temporal candidates includes N candidates, cand_list{C1, C2, C3, . . . C_N}. Each candidate in the candidate set for part B is checked to ensure it is not the same as the prune motion information. The candidate is removed from the candidate set if the motion information equals to the prune motion information and if part A is coded in Inter, Skip, or Merge mode. The motion information may be one or a combination of a motion vector including MV_x and MV_y, reference list, reference index, and other merge-mode-sensitive information such as local illumination compensation flag.

Merge_skip_mode_cand_list_build (part B)
{

Prune_MI = MotionInfo_part_A //MI = motion info
make candidate list for motion merge mode or skip mode for part B

result is cand_list{C1, C2, C3, ... C_N)

```
  for each entry C_i in cand_list
  {
```

if ((motion information of C_i == Prune_MI) and

(part A is inter or skip or merge mode))
prune (remove from list) the C_i

}

}

In some examples, the candidate set pruning process of the second embodiment may be adaptively enabled or disabled according to a flag signaled in a sequence level, picture level, slice level, or PU level. For example, a flag spatial_based_pruning_en is signaled, and the flag with value 1 indicates the candidate set pruning process is enabled, whereas the flag with value 0 indicates the candidate set pruning process is disabled. The flag spatial_based_pruning_en is inferred to be 1 if this flag is not present.

The second embodiment provides a general rule for the candidate set pruning method applicable to all kinds of binary-tree splitting in the binary-tree structure, where the parent block before binary-tree splitting may be square or rectangular shape. For example, the neighboring block 802 is located at the left of the current block 804 as shown in FIG. 8A, or the neighboring block 822 is located above the current block 824 as shown in FIG. 8B if the parent block is square shape. The neighboring block 902 is located at the left of the current block 904 as shown in FIG. 9A, the neighboring block 922 is located above the current block 924 as shown in FIG. 9B, the neighboring block 942 is located at the left of the current block 944 as shown in FIG. 9C, or the neighboring block 962 is located above the current block 964 as shown in FIG. 9D if the parent block is rectangular shape. The candidate set for the current block is scanned and any candidate with motion information equals to motion information of the neighboring block is pruned when the candidate set pruning method is enabled.

Third Embodiment A third embodiment is similar to the first embodiment except the neighboring block in the first embodiment is a leaf node and therefore not further split, whereas in the third embodiment, a neighboring block of the current block partitioned from the same parent block by binary-tree splitting may be further split into smaller sub-blocks. The neighboring block of the third embodiment is not a leaf node as this neighboring block is further split into sub-blocks for prediction or other coding processing. In an example of the third embodiment, leaf blocks, such as PUs, are generated by a QTBT splitting structure, and a minimum block is defined as the minimum allowable block size for the PUs so each PU is greater than or equal to the minimum block. The minimum block has a size of M×M, where M is an integer greater than 1. For example, the minimum block is 4×4 according to the HEVC standard. The spatial candidate prohibiting method of the third embodiment first checks if motion information of all minimum blocks inside the neighboring block are all the same, and if all minimum blocks are coded in Inter prediction including AMVP, Merge, and Skip modes. The spatial candidate prohibiting method prohibits the spatial candidate derived from any sub-blocks inside the neighboring block if the motion information of all minimum blocks inside the neighboring block are the same and the sub-blocks are coded in Inter prediction.

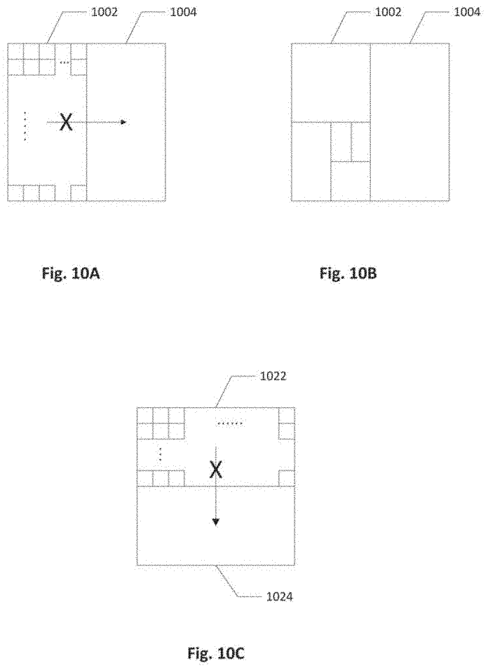

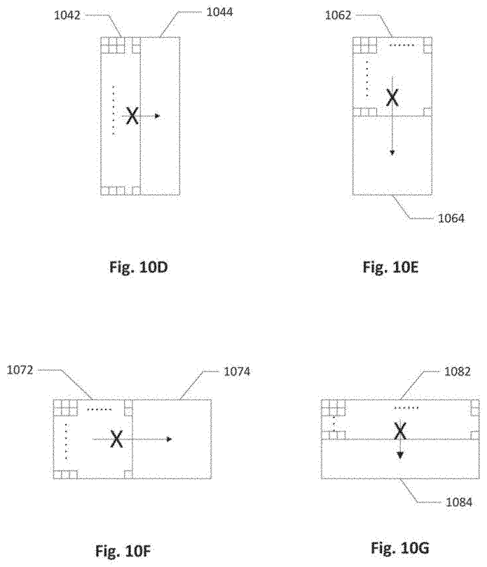

FIG. 10A and FIG. 10B illustrate an example of the third embodiment, where a current block 1004 is a leaf node and a neighboring block 1002 of the current block 1004 is further split in a binary tree manner as shown in FIG. 10B. The spatial candidate prohibiting method of the third embodiment is applied when constructing a candidate set for coding the current block 1004. Motion information of sub-blocks split from the neighboring block 1002 may be different to each other, and if the motion information of all sub-blocks inside the neighboring block 1002 are the same and all the sub-blocks are coded in Inter, Merge, or Skip mode, the spatial candidate from any sub-block inside the neighboring block 1002 is prohibited to be included in the candidate set for the current block 1004. An example of the third embodiment checks each minimum block inside the neighboring block 1002 as shown in FIG. 10A to determine if the motion information of all sub-blocks in the neighboring block are the same. The partitioned leaf block will never be smaller than the minimum block. The spatial candidate prohibiting method of the third embodiment may be applied to other exemplary binary-tree splitting structures as shown in FIGS. 10C, 10D, 10E, 10F, and 10G if the neighboring blocks 1022, 1042, 1062, 1072, and 1082 are further partitioned into sub-blocks for prediction.

Fourth Embodiment A candidate set pruning method of a fourth embodiment is similar to the candidate set pruning method of the second embodiment, a neighboring block 1002 in the fourth embodiment is further split into smaller sub-blocks as shown in FIG. 10B, whereas the neighboring block and the current block are the leaf nodes of the binary tree structure or the QTBT structure according to the second embodiment. The neighboring block and the current block in the fourth embodiment are partitioned from a parent block according to binary-tree splitting, and the neighboring block is not the leaf node as it is further partitioned. The candidate set pruning method of the fourth embodiment first checks if motion information in the neighboring block are all the same and all sub-blocks in the neighboring block are Inter predicted blocks, then records the motion information MI_sub if the motion information are the same and all sub-blocks are Inter predicted blocks. A way to determine whether all the motion information in the neighboring block are same or different includes scanning all minimum blocks inside the neighboring block, and the pruning process of the fourth embodiment is only applied if motion information of all the minimum blocks inside the neighboring block are the same. The minimum block is defined as the minimum allowable size for splitting, that is, the partitioned leaf block will never be smaller than the minimum block.

A candidate set for the current block is required when the current block is coded in Merge or Skip mode, and after obtaining an initial candidate set for the current block, each candidate in the initial candidate set is compared with the recorded motion information MI_sub. The candidate having the same motion information with the recorded motion information MI_sub is pruned or removed from the candidate set for the current block. The pseudo codes in the following demonstrate an example of the candidate set pruning method applied to a candidate set cand_list{C1, C2, C3, . . . C_N} for a current block part B after obtaining the recorded motion information MI_sub derived from a neighboring block part A.

Merge_skip_mode_cand_list_build (part B)

{

if(MI_sub exists)

Prune_MI = MI_sub//MI = motion info

else

Prune_MI = invalid value (NULL value)

make candidate set for motion merge mode for part B

result is cand_list{C1, C2, C3, ... C_N)

```
  for each entry C_i in cand_list
  {
```

```
  if (motion information of C_i == Prune_MI) and
  (Prune_MI != NULL)
```

prune (remove from list) the C_i

}

}

In the above pseudo codes, Merge_skip_mode_cand_list_build (part B) is a process to build the candidate set for part B in the fourth embodiment, and prune MI is a variable to store motion information for the pruning process. The motion information here is defined as one or a combination of {MV_x, MV_y, reference list, reference index, other merge-mode-sensitive information such as local illumination compensation flag}.

A flag spatial_based_pruning_en may be used to switch on or off for the candidate set pruning method of the fourth embodiment, where the flag with value 1 indicates the candidate set pruning method is enabled and the flag with value 0 indicates the candidate set pruning method is disabled. The minimum sizes of units for signaling the flag may be separately coded in a sequence level, picture level, slice level, or PU level.

Similar to the previous embodiments, the candidate set pruning method of the fourth embodiment proposed a general rule applicable to all kinds of binary-tree splitting in the binary tree structure or other combined partitioned structure involving binary-tree splitting such as the QTBT structure. FIGS. 10A, 10C, 10D, 10E, 10F, and 10G demonstrate some examples of possible binary-tree splitting for the neighboring block and the current block sharing the same parent block. The candidate set for the current block is checked to remove any candidate having the same motion information as the motion information derived the neighboring block if sub-blocks in the neighboring block are coded in Inter prediction and the motion information is the same.

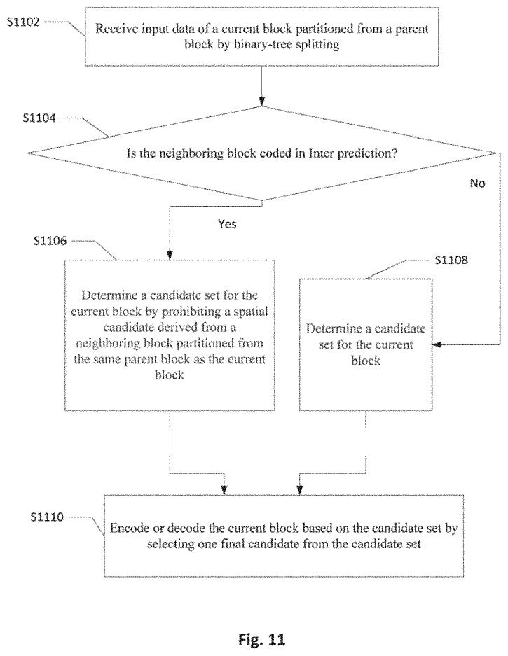

FIG. 11 is a flow chart illustrating an embodiment of the video data processing method for coding a binary-tree splitting block by constructing a candidate set. The video data processing method described in FIG. 11 may be applied to binary-tree splitting blocks coded in Merge mode or Skip mode. Input data associated with a current block is received from a processing unit or a memory device in step S1102, where the current block and a neighboring block are split from the same parent block by binary-tree splitting. Step S1104 checks if the neighboring block is coded in Inter prediction such as AMVP mode, Merge mode, or Skip mode. If the neighboring block is coded in Inter prediction, a candidate set is constructed for the current block by prohibiting a spatial candidate derived from the neighboring block in step S1106; else the candidate set is constructed for the current block according to a conventional candidate set construction method in step S1108. After constructing the candidate set in step S1106 or step S1108, the current block is encoded or decoded based on the candidate set by selecting one final candidate from the candidate set in step S1110. At an encoder side, the final candidate is selected by an encoder algorithm such as rate-distortion optimization (RDO), whereas at a decoder side, the final candidate is selected by an index signaled in the video bitstream. The current block reuses motion information of the final candidate for motion prediction or motion compensation.

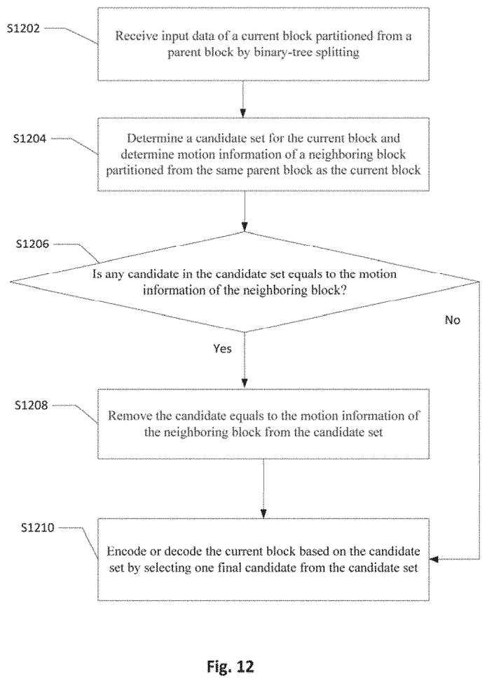

FIG. 12 is a flow chart illustrating another embodiment of the video data processing method for coding a binary-tree splitting block by constructing a candidate set for Merge mode or Skip mode. In step S1202, input data associated with the current block is received from a processing unit or a memory device. The current block and a neighboring block are partitioned from a parent block by binary-tree splitting. To code the current block in Merge mode or Skip mode, a candidate set is determined for the current block, and motion information of the neighboring block are also determined and stored in step S1204. Step S1206 checks if any candidate in the candidate set equals to the motion information of the neighboring block; and if there is any candidate equals to the motion information of the neighboring block, that candidate is removed from the candidate set in step S1208. The current block is encoded or decoded based on the candidate set by selecting one final candidate from the candidate set in step S1210.

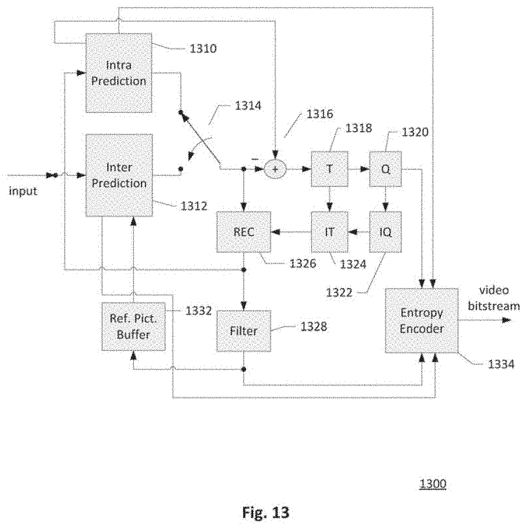

FIG. 13 illustrates an exemplary system block diagram for a Video Encoder 1300 implementing various embodiments of the present invention. Intra Prediction 1310 provides intra predictors based on reconstructed video data of a current picture. Inter Prediction 1312 performs motion estimation (ME) and motion compensation (MC) to provide predictors based on video data from other picture or pictures. To encode a current block in Merge or Skip mode according to some embodiments of the present invention, a candidate set is constructed by prohibiting a spatial candidate derived from a neighboring block if the neighboring block and the current block are partitioned from the same parent block by binary-tree splitting and if the neighboring block is coded in Inter prediction. If the neighboring block is further partitioned into smaller sub-blocks, the spatial candidate prohibiting method is applied when all motion information inside the neighboring block are the same and all the sub-blocks are coded in Inter prediction. According to some other embodiments, a pruning process includes scanning the candidate set for the current block to check if any candidate having motion information equals to the motion information of the neighboring block, and removing the candidate having motion information equals to the motion information of the neighboring block from the candidate set. In cases when the neighboring block is not the leaf node, the pruning process is applied if all motion information inside the neighboring block are the same and sub-blocks in the neighboring block are coded in Inter prediction. The Inter Prediction 1312 determines a final candidate from the candidate set for the current block to derive a predictor for the current block. Either Intra Prediction 1310 or Inter Prediction 1312 supplies the selected predictor to Adder 1316 to form prediction errors, also called residues. The residues of the current block are further processed by Transformation (T) 1318 followed by Quantization (Q) 1320. The transformed and quantized residual signal is then encoded by Entropy Encoder 1334 to form a video bitstream. The video bitstream is then packed with side information. The transformed and quantized residual signal of the current block is processed by Inverse Quantization (IQ) 1322 and Inverse Transformation (IT) 1324 to recover the prediction residues. As shown in FIG. 13, the residues are recovered by adding back to the selected predictor at Reconstruction (REC) 1326 to produce reconstructed video data. The reconstructed video data may be stored in Reference Picture Buffer (Ref. Pict. Buffer) 1332 and used for prediction of other pictures. The reconstructed video data from REC 1326 may be subject to various impairments due to the encoding processing, consequently, In-loop Processing Filter 1328 is applied to the reconstructed video data before storing in the Reference Picture Buffer 1332 to further enhance picture quality.

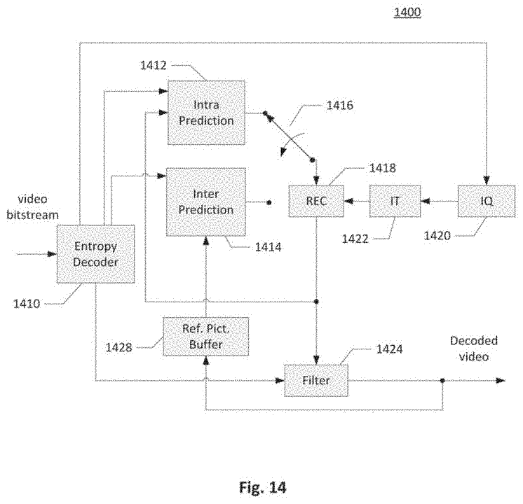

A corresponding Video Decoder 1400 for Video Encoder 1300 of FIG. 13 is shown in FIG. 14. The video bitstream encoded by a video encoder is the input to Video Decoder 1400 and is decoded by Entropy Decoder 1410 to parse and recover the transformed and quantized residual signal and other system information. The decoding process of Decoder 1400 is similar to the reconstruction loop at Encoder 1300, except Decoder 1400 only requires motion compensation prediction in Inter Prediction 1414. Each block is decoded by either Intra Prediction 1412 or Inter Prediction 1414. Switch 1416 selects an intra predictor from Intra Prediction 1412 or Inter predictor from Inter Prediction 1414 according to decoded mode information. Inter Prediction 1414 of some embodiment constructs a candidate set for a binary-tree splitting current block by prohibiting a spatial candidate derived from a neighboring block partitioned from the same parent block as the current block if the neighboring block is coded in Inter prediction. Inter Prediction 1414 of some other embodiment constructs the candidate set for the current block with a pruning process which removes any candidate in the candidate set having same motion information as motion information of the neighboring block. In cases when the neighboring block is further partitioned into sub-blocks for prediction, the spatial candidate prohibiting method or the pruning method is applied only if the motion information inside the neighboring block are the same and all the sub-blocks are coded in Inter prediction. Inter Prediction 1414 derives a predictor for the current block by selecting one final candidate from the candidate set. The transformed and quantized residual signal associated with each block is recovered by Inverse Quantization (IQ) 1420 and Inverse Transformation (IT) 1422. The recovered residual signal is reconstructed by adding back the predictor in REC 1418 to produce reconstructed video. The reconstructed video is further processed by In-loop Processing Filter (Filter) 1424 to generate final decoded video. If the currently decoded picture is a reference picture, the reconstructed video of the currently decoded picture is also stored in Ref. Pict. Buffer 1428 for later pictures in decoding order.

Various components of Video Encoder 1300 and Video Decoder 1400 in FIG. 13 and FIG. 14 may be implemented by hardware components, one or more processors configured to execute program instructions stored in a memory, or a combination of hardware and processor. For example, a processor executes program instructions to control receiving of input data associated with a current picture. The processor is equipped with a single or multiple processing cores. In some examples, the processor executes program instructions to perform functions in some components in Encoder 1300 and Decoder 1400, and the memory electrically coupled with the processor is used to store the program instructions, information corresponding to the reconstructed images of blocks, and/or intermediate data during the encoding or decoding process. The memory in some embodiment includes a non-transitory computer readable medium, such as a semiconductor or solid-state memory, a random access memory (RAM), a read-only memory (ROM), a hard disk, an optical disk, or other suitable storage medium. The memory may also be a combination of two or more of the non-transitory computer readable medium listed above. As shown in FIGS. 13 and 14, Encoder 1300 and Decoder 1400 may be implemented in the same electronic device, so various functional components of Encoder 1300 and Decoder 1400 may be shared or reused if implemented in the same electronic device.

Embodiments of the candidate set constructing method for a current block partitioned by binary-tree splitting may be implemented in a circuit integrated into a video compression chip or program code integrated into video compression software to perform the processing described above. For examples, determining of a current mode set for the current block may be realized in program code to be executed on a computer processor, a Digital Signal Processor (DSP), a microprocessor, or field programmable gate array (FPGA). These processors can be configured to perform particular tasks according to the invention, by executing machine-readable software code or firmware code that defines the particular methods embodied by the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing video data in a video coding system, wherein video data in a picture is partitioned into blocks, comprising:
receiving input data associated with a current block in a current picture, wherein the current block and a neighboring block are split from a parent block by binary-tree splitting;
determining a candidate set for the current block by prohibiting a spatial candidate derived from the neighboring block or removing the spatial candidate from the candidate set if the neighboring block is coded in Inter prediction; and
encoding or decoding the current block based on the candidate set by selecting one final candidate from the candidate set and deriving a predictor for the current block according to motion information of the final candidate.

2. The method of claim 1, wherein a flag is signaled to indicate whether the candidate set prohibits the spatial candidate derived from the neighboring block.

3. The method of claim 2, wherein the flag is signaled in a sequence level, picture level, slice level, or Prediction Unit (PU) level.

4. The method of claim 1, wherein determining the candidate set further comprises a pruning process, the pruning process comprises scanning the candidate set to determine if any candidate in the candidate set equals to the spatial candidate derived from the neighboring block, and removing the candidate equals to the spatial candidate from the candidate set.

5. The method of claim 4, wherein motion information of the spatial candidate derived from the neighboring block are stored and compared to motion information of each candidate in the candidate set.

6. The method of claim 5, wherein the motion information comprises one or a combination of motion vector, reference list, reference index, and merge-mode-sensitive information.

7. The method of claim 4, wherein a flag is signaled to indicate whether the pruning process is enabled.

8. The method of claim 7, wherein the flag is signaled in a sequence level, picture level, slice level, or Prediction Unit (PU) level.

9. The method of claim 1, wherein the neighboring block is further split into a plurality of sub-blocks for motion estimation or motion compensation, and determining the candidate set further comprises checking if motion information inside the neighboring block are the same, and prohibiting the spatial candidate derived from any sub-block in the neighboring block if the motion information inside the neighboring block are all the same and the sub-blocks are coded in Inter prediction.

10. The method of claim 9, wherein checking if motion information inside the neighboring block comprises checking every minimum block inside the neighboring block, wherein each minimum block has a size of M×M and each of the sub-blocks is larger than or equal to M×M.

11. The method of claim 9, wherein a flag is signaled to indicate whether the candidate set prohibits the spatial candidate derived from any sub-block in the neighboring block.

12. The method of claim 1, wherein the neighboring block is further split into a plurality of sub-blocks for motion prediction or motion compensation, and determining the candidate set further comprises checking if motion information inside the neighboring block are the same, and performing a pruning process if the motion information inside the neighboring block are all the same; the pruning process comprises scanning the candidate set to determine if any candidate in the candidate set equals to the spatial candidate derived from any sub-block in the neighboring block, and removing the candidate equals to the spatial candidate from the candidate set.

13. The method of claim 12, wherein checking if motion information inside the neighboring block comprises checking every minimum block inside the neighboring block, wherein each minimum block has a size of M×M and each of the sub-blocks is larger than or equal to M×M.

14. The method of claim 12, wherein a flag is signaled to indicate whether the pruning process is enabled.

15-18. (canceled)

19. An apparatus of processing video data in a video coding system, wherein video data in a picture is partitioned into blocks, the apparatus comprising one or more electronic circuits configured for:
receiving input data associated with a current block in a current picture, wherein the current block and a neighboring block are split from a parent block by binary-tree splitting;
determining a candidate set for the current block by prohibiting a spatial candidate derived from the neighboring block if the neighboring block is coded in Inter prediction; and
encoding or decoding the current block based on the candidate set by selecting one final candidate from the candidate set and deriving a predictor for the current block according to motion information of the final candidate.

20. A non-transitory computer readable medium storing program instruction causing a processing circuit of an apparatus to perform video processing method, and the method comprising:
receiving input data associated with a current block in a current picture, wherein the current block and a neighboring block are split from a parent block by binary-tree splitting;
determining a candidate set for the current block by prohibiting a spatial candidate derived from the neighboring block if the neighboring block is coded in Inter prediction; and
encoding or decoding the current block based on the candidate set by selecting one final candidate from the candidate set and deriving a predictor for the current block according to motion information of the final candidate.
